(19) United States
(12) Patent Application Publication
(10) Pub. No.: US 2011/0203393 A1
(43) Pub. Date: Aug. 25, 2011

(54) CROSSCUT GRAIN SAMPLER

(75) Inventors: Glenn Byrnes, Eston (CA); Bill Woods, Eston (CA)

(73) Assignee: WEST CENTRAL ROAD & RAIL LTD., Eston, Saskatchewan (CA)

(21) Appl. No.: 12/674,790

(22) PCT Filed: Sep. 11, 2007
(86) PCT No.: PCT/CA07/01596

§ 371 Date: Mar. 11, 2010

(30) Foreign Application Priority Data
Aug. 27, 2007 (CA) 2599026

(51) Int. Cl. G01N 1/20

(52) U.S. Cl. 73/864.31

(57) ABSTRACT

A sampling device having an elongate member positioned in the connecting section of a swing type auger is provided. The member has a channel facing into a flow of particulate matter passing through the connecting section and an open end. The member is attached to a rotating shaft. When the auger system is in operation and particulate matter is flowing through the connecting section, the arm rotates perpendicularly through the flow of particulate material and a portion of this particulate material is collected in the channel of the rotating member. The rotation of the member causes the collected particulate material to move along the length of the rotating member until it is thrown out the open end of the member, where a sample can be collected through an aperture in the side of the connecting section.

This invention is in the field of particulate material sampling devices and more particularly is directed to a particulate material sampling device incorporated into a swing auger.

### BACKGROUND

A definite need exists for a low cost grain sampler that can be used on the farm and provide a good representative sample of the grain being sampled. Typically, when a farmer agrees to deliver a load of grain to a buyer, a farmer will first deliver a sample of the grain to the buyer, so that the buyer and the farmer can determine a price for the load of grain. The buyer will then provide the farmer with a price estimate for the load based on the sample of grain taken by the farmer. However, if the load of grain that is eventually delivered by the farmer to the buyer does not match the quality of the sample that was provided, which the buyer used to determine the price estimate, complications for the farmer arise. This could mean a change in the price the buyer pays for the load, or if the quality of the load varies enough from the sample, the buyer may refuse to take delivery of the load of grain, requiring the farmer to take the load of grain back to the farm. In some instances, delivery distances can be quite far and it can be quite costly to the farmer to have the grain returned back to the farm after paying the cost of having the grain delivered in the first place.

It has also become common for farmers to use producer cars. Farmers who load grain directly into railway cars must wait for official grading at a port which can be quite far from the loading point. Accurate samples of the grain are required by the farmer, who must rely heavily on an accurate sample of the grain load taken at the farm to verify the grade of the grain before shipping it.

Additionally, food safety issues and problems relating to genetically engineered crops have increased the need for a fairly accurate grain sample to be taken from a load of grain, with many purchasers requiring these fairly accurate samples of a load of grain.

Canadian Patent Application No. 2,448,476 discloses a device for sampling grain as it exits an auger. However, the device is positioned in its own casing beneath a discharge spout of the auger, which requires the device to be positioned quite high off the ground, preventing an operator from easily obtaining a grain sample with the device. Additionally, the placement of the device under a spout at the end of the auger requires the spout of the auger to be raised higher over a bin or other container the grain is being loaded in, because the casing must also clear the opening to the bin or other container. Finally, the placement of this disclosed device requires it to be driven by impeller blades attached beneath the device increasing the complexity of the device and requiring the device's performance to be based on getting adequate flow rates of grain through the casing in order to properly drive the sampling device.

A need exists for a low cost grain sampler that can be used on the farm and provide a good representative sample of the grain being sampled.

### SUMMARY OF THE INVENTION

It is an object of the present invention to provide a device and method that overcomes problems in the prior art.

In an aspect of the invention, an auger assembly having a sampling device for collecting a sample of particulate material passing through the auger assembly is provided. The auger assembly comprises: a first auger section having an intake end and a discharge end, the first auger section operative to move particulate material from the intake end of the first auger section to the discharge end of the first auger section; a second auger section having an intake end and a discharge end, the second auger section operative to move particulate material from the intake end of the second auger section to the discharge end of the second auger section; a connecting section defining a passageway and positioned between the discharge end of the first auger section and the intake end of the second auger section, the connecting section operative to direct a flow of particulate material exiting from the discharge end of the first auger section through the passageway to the intake end of the second auger section while the auger assembly is in operation; an elongate member having a channel with an open end at a first end of the member, the member rotatably mounted in the connecting section so that rotation of the elongate member defines a swept area in a first plane, the first plane substantially perpendicular to the flow of particulate material passing through the passageway while the auger assembly is in operation, the channel substantially facing into the flow of particulate material passing through the passageway while the auger assembly is in operation; an aperture in the connecting section, passing into the passageway and at least partially positioned in the first plane; and drive means operative to both drive the second auger section and rotate the member.

In another aspect of the invention, an auger assembly having a sampling device for collecting a sample of particulate material passing through the auger assembly is provided. The auger assembly comprises: a first auger section having an intake end and a discharge end, the first auger section operative to move particulate material from the intake end of the first auger section to the discharge end of the first auger section; a second auger section having an intake end and a discharge end, the second auger section operative to move particulate material from the intake end of the second auger section to the discharge end of the second auger section; a connecting section defining a passageway and positioned between the discharge end of the first auger section and the intake end of the second auger section, the connecting section operative to direct a flow of particulate material exiling from the discharge end of the first auger section through the passageway to the intake end of the second auger section while the auger assembly is in operation; an elongate member rotatably mounted in the connecting section and having a channel substantially facing into the flow of particulate material through the passageway while the auger system is in operation, the channel having an open end at a first end of the member, the member rotatably mounted in the connecting section so that rotation of the elongate member causes the member to sweep substantially through a cross-section of the flow of particulate material passing through the passageway while the auger assembly is in operation and collecting a portion of the flow of particulate material in the channel, wherein the rotation of the member forces the particulate material collected in the channel along a length of the channel and out the open end at the first end of the member; an aperture in the connecting section, passing into the passageway and positioned so that at least a portion of the collected particulate material being forced out the open end of the first end of the member will exit the connecting section through the aperture; and drive means operative to both drive the second auger section and rotate the member.

In another aspect, a method of collecting a sample of particulate material from an auger assembly having a first auger section and a second auger section connected with a connecting section between the discharge end of the first auger section and the intake end of the second auger section is provided. The method comprises: while the auger assembly is in operation, rotating an elongate member, in the connecting section, in a plane substantially perpendicular to a flow of particulate material passing from the discharge end of the first auger section to the intake end of the second auger section; collecting some of the flow of particulate material in a channel in the elongate member as the flow of particulate material passes the rotating member; moving the particulate material collected in the channel towards an open end of the member by continuing to rotate the member; and ejecting a portion of the particulate material from the open end of the channel out of the connecting section.

A sampling device is provided for an auger system having a first auger section and a second auger section. The auger system is a swing auger system and a connecting section connects the discharge end of the first auger section to the intake end of the second auger section so that the first auger section can rotate around the intake end of the second auger section and typically tilt up and down relative to the second auger section. In operation, particulate material, such as grain, is loaded into a hopper at an intake end of the first auger section where it is carried up the auger section to the discharge end of the first auger section. From the discharge end of the first auger section, the particulate material is directed by the connecting section to the intake end of the second auger section, where the particulate material is then lifted up the second auger section to be discharge into the grain bin or other storage container that is being loaded with the auger system.

The sampling device has an elongate member positioned in the connecting section. The member has a channel facing up towards the discharge end of the first auger section and an open end at a first end of the member. The second end of the member is attached to a rotating shaft running from a power take-off input on the intake end of the second auger section that is used to drive the second auger section. When the auger system is in operation and particulate material is flowing through the connecting section from the discharge end of the first auger section to the intake end of the second auger section, the member is rotating through the flow of particulate material and a small portion of this flow of particulate material is collected in the channel of the rotating member. The rotation of the member creates centripetal force on the collected particulate matter which causes the collected particulate material to move along the length of the rotating member until it is thrown out the open end of the member.

During normal operation of the auger system, when an operator does not wish to take a sample of particulate material, the particulate material thrown out the open end of the rotating member hits the inside surface of the connecting section and falls with the rest of the flow of particulate material passing through the connecting section, into the intake end of the second auger section. However, if the operator wants to take a sample of particulate material while the auger system is running, the operator uncovers an aperture in the side of the connecting section and some of the particulate material collected and thrown out of the open end of the rotating member will pass out of the connecting section through the aperture and can be taken as a sample.

By placing the sampling device in the connecting section between a first auger section and second auger section in a swing auger, an operator can easily access the aperture used to obtain a sample of particulate matter. The connecting section on a swing auger is typically easily reachable by an operator standing on the ground beside the connecting section without requiring the operator to have to climb a ladder or be lifted up to the device. Rather, the operator can usually walk over to the aperture in the connecting section and obtain a sample. Additionally, by placing the sampling device in the connecting section of the auger system, it is placed in proximity to the power take-off connection of the auger system allowing the rotating member to be connected to the drive line of the auger system and driven by the power take-off.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of a swing auger system incorporating a grain sampler;

FIG. 2 is a perspective view of a first auger section of the swing auger system shown in FIG. 1;

FIG. 3 is side view of a discharge end of the first auger section and the intake end of the second auger section; and

FIG. 4 is an exploded perspective view of the connecting section between the first auger section and the second auger section.

### DETAILED DESCRIPTION OF THE ILLUSTRATED EMBODIMENTS

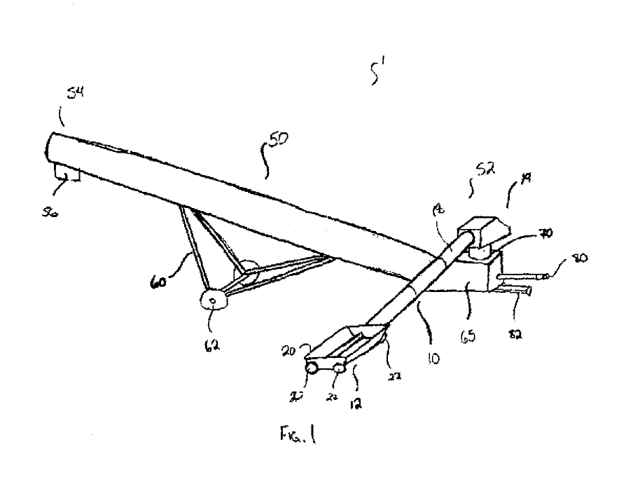

FIG. 1 illustrates an auger system 1. The auger system 1 has a first auger section 10 and a second auger section 50. The first auger section 10 is a swing auger and is pivotally connected to the second auger section 50 which is a main auger. The first auger section 10 is used to load particulate material, such as grain, from a low point, such as under a grain truck and lift it to be loaded into an intake end 52 of the second auger section 50. The second auger section 50 is typically much longer than the first auger section 10, with the first auger section 10 typically being just long enough to lift particulate material loaded in the intake end 12 of the first auger section 10 to the intake end 52 of the second auger section 50 and the second auger section 50 providing the majority of the lift provided by the auger system 1. The second auger section 50 lifts the particulate material along its length, where it is then discharged from a discharge end 54 of the second auger section 50 (typically from a discharge spout 56) into a grain bin (not shown) or other container that the particulate material is being moved to.

### First Auger Section

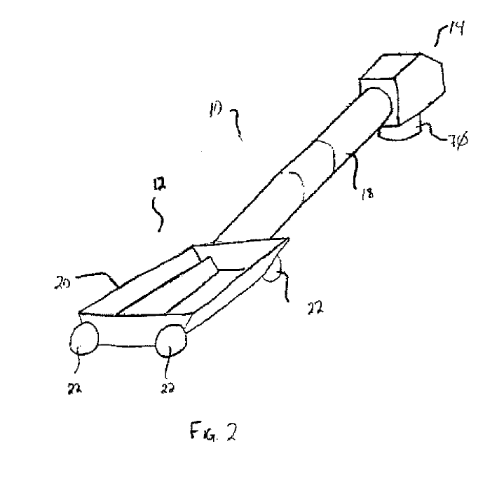

FIG. 2 illustrates the first auger section 10 or swing auger portion. The first auger section 10 has a hopper 20 at the intake end 12 of the first auger section 10. Typically, the hopper 20 is constructed such that it is low enough for collecting particulate material from a grain truck or hopper trailer. From the hopper 20 a tube section 18 runs upwards to a discharge end 14 of the first auger section 10 ending in a connecting section 70 forming a discharge spout for the first auger section 10.

A number of wheels 22 are rotatably attached to the hopper 20 and positioned perpendicular to the tube section 18 so that the hopper 20 can be pivoted around the discharge end 14 of the first auger section 10. These wheels 22 can be attached so that they pivot freely, requiring an operator to manually push or move the hopper 20 or these wheels 22 can be driven, such as by hydraulics, so that an operator can drive the wheels 22 in the direction he or she wants to move the hopper 20.

During operation of the first auger section 10, particulate material that is loaded into the hopper 20 moves up the tube section 18 where it is discharged out of the discharge end 14 of the first auger section 10.

### Second Auger Section

Referring again to FIG. 1, the second auger section 50 is a conventional auger as is well known in the art with an intake end 52 where particulate material is loaded into the second auger section 50. From the intake end 52 particulate material is carried up the second auger section 50 to be discharged out of a discharge end 54 of second auger section 50 (typically through a discharge spout 56).

A framework 60 and transport wheels 62 are connected to the second auger section 50 to allow the second auger section 50 to be transported. A tow hitch 82 is provided that can be connected to a tow vehicle and in conjunction with the framework 60 and transport wheels 62, can be used to transport the auger system 1.

The first auger section 10 has an auger boot 65 at the intake end 52 that is connected to the discharge end 14 of the first auger section 10 by the connecting section 70. The connecting section 70 directs particulate material exiting the discharge end 14 of the first auger section 10 through the passageway and into the intake end 52 of the second auger section 50, where the particulate material is then lifted up the length of the second auger section 50 to be discharged out the end of the discharge end 54 of the second auger section 50, typically through a discharge spout 56.

A power take-off connection 80 is provided leading into the auger boot 65 of the second auger section 50 to drive the flighting in the section auger section 50, and often the first auger section 10, if the first auger section 10 does not use hydraulics to drive its flighting.

### Connecting Section

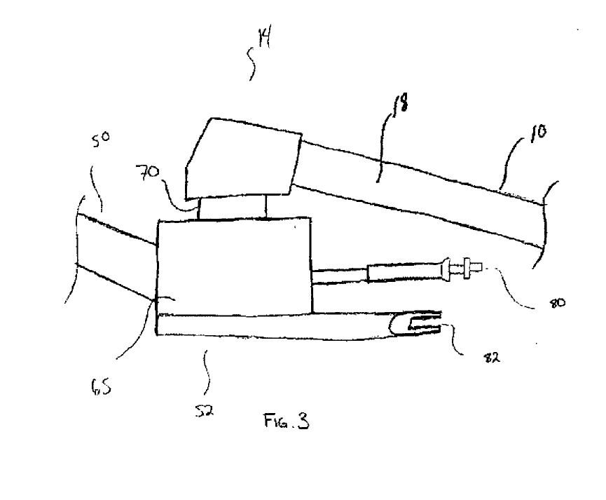

FIG. 3 illustrates the connecting section 70 between the first auger section 10 and the second auger section 50. A connecting section 70 forming a passageway is rigidly connected to the discharge end 14 of the first auger section 10 and connected to the auger boot 65 on the intake end 52 of the second auger section 50. The connecting section 70 connects the discharge end 14 of the first auger section 10 to the intake end 52 of the second auger section so that the discharge end 14 of the first auger section 10 can rotate around auger boot 65 and also typically, pivot relative to the auger boot 65 allowing the angle of the tube section 18 of the first auger section to be varied somewhat. This allows an operator to move the first auger section 10 around the intake end 52 of the second auger section 50, while the second auger section 50 remains in one place.

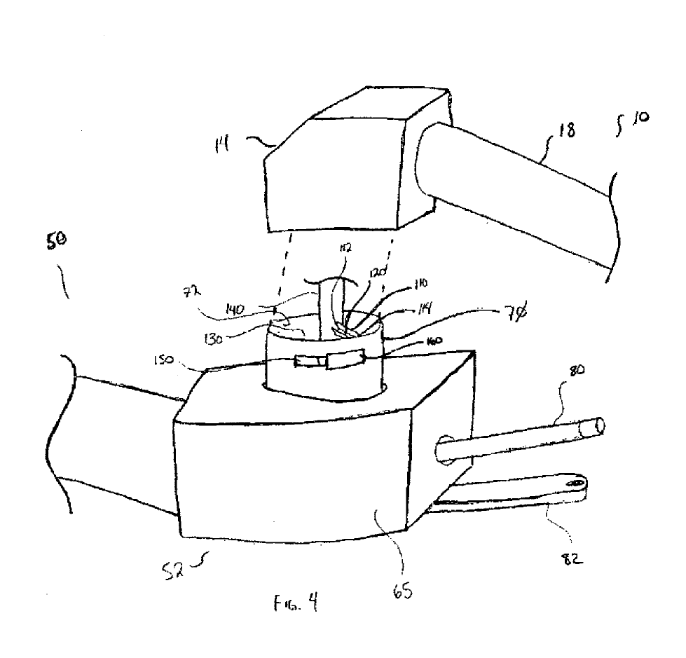

FIG. 4 illustrates an exploded perspective view of the connecting section 70. A member 110 forming a channel 120 is connected at a first end 112 to a shaft 140 running through the center of the passageway 130 formed by the connecting section 70. The shaft 140 is typically a shaft taken off from the power take-off connection 60 passing into the auger boot 65. Because the connecting section 70 is directly above the auger boot 65, it is not difficult to run the shaft 14(1 from the power take-off connection 60 powering the second auger section 50. In some cases the first auger section 10 is also powered from the power take-off section 60 and the shaft 140 is already in place on the auger system 1 and member 110 can be connected to the already present shaft 140.

A second end 114 of the member 110 is open, causing the channel 120 formed by the member 110 to be open-ended. The channel 120 formed by the member 110 faces upwards so that when the auger system 1 is in operation and particulate material is passing from the discharge end 14 of the first auger section 10 through the connecting section 70 to the intake end 52 of the second auger section 50, the channel 120 in the member 110 is facing upwards into the flow of particulate material passing through the connecting section 70, so that some of the particulate material falls into the channel 120.

An aperture 150 passes through the connecting section 70 into the passageway defined by the connecting section 70. The aperture 150 is positioned through the connecting section 70 so that it is positioned in the same plane that the member 110 rotates in. A cover 160 allows an operator to cover the aperture 150 when a sample of particulate material is not being taken.

### In Operation

Referring to FIG. 1, when particulate material, such as grain or some other crop material, is loaded into the hopper 20 on the intake end 12 of the first auger section 10, the particulate material is moved from the hopper 20 up the length of the first auger section 10. When the particulate material is lifted up the to the discharge end 14 of the first auger section 10, the particulate material is discharged from the first auger section 10, through the passageway defined by the connecting section 70, to the intake end 52 of the second auger section 50. The passageway defined by the connecting section 70 directs the particulate material falling from the discharge end 14 of the first auger section 10 to the intake end 52 of the second auger section 50. The second auger section 50 then lifts the particulate material up the length of the second auger section 50 to the discharge end 54 of the second auger section 50 where the particulate material is discharged out the spout 56 into a bin, grain trailer, etc.

Referring to FIG. 4, the particulate material exits the discharge end 14 of the first auger section 10 and is directed through the connecting section 70 to the intake end 52 of the second auger section 50. As the particulate material passes through the connecting section 70, the member 110, connected at the first end 112 to the shaft 140, is rotating, causing the member 110 to rotate, sweeping through a circular area slightly smaller than the cross-sectional area of the passageway defined by the connecting section 70. The channel 120 in the member 110 faces upward into the downward falling flow of particulate material, catching some of the particulate material in the channel 120 as the particulate material flows downwards past the sweeping member 110.

The rotation of the member 110 creates centripetal force which forces the particulate material collected in the channel 120 of the member 110 down the length of the channel 120. With the second end 114 of the member 110 being open, the collected particulate material moves down the channel 120 as a result of the rotation of the member 110, until the particulate material is thrown out the open second end 114 of the member 110. If the operator of the auger system 1 does not want to take a particulate material sample, he or she leaves the cover 160 over the aperture 150 in the casing 70. The particulate material will then be thrown out the open first end 114 of the channel 120 where it will hit an inner surface 72 of the connecting section 70 and fall through an annulus formed between the first end 114 of the member and the inner surface 72 of the connecting section 70, down into the intake end 52 of the second auger section 50. If the operator wants to take a sample of the particulate material passing through the auger system 1, he or she opens the cover 160 covering the aperture 150 and some of the particulate material being thrown off the open second end 114 of the rotating member 110 is thrown out of the uncovered aperture 150, and optionally down a spout (not shown). The operator will then collect the expelled particulate material for the sample.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. An auger assembly having a sampling device for collecting a sample of particulate material passing through the auger assembly, the auger assembly comprising:
a first auger section having an intake end and a discharge end, the first auger section operative to move particulate material from the intake end of the first auger section to the discharge end of the first auger section;
a second auger section having an intake end and a discharge end, the second auger section operative to move particulate material from the intake end of the second auger section to the discharge end of the second auger section;
a connecting section defining a passageway and positioned between the discharge end of the first auger section and the intake end of the second auger section, the connecting section directing a flow of particulate material exiting from the discharge end of the first auger section through the passageway to the intake end of the second auger section while the auger assembly is in operation;
an elongate member having a channel with an open end at a first end of the member, the member rotatably mounted in the connecting section so that rotation of the elongate member defines a swept area in a first plane, the first plane substantially perpendicular to the flow of particulate material passing through the passageway while the auger assembly is in operation, the channel at least partially facing into the flow of particulate material passing through the passageway while the auger assembly is in operation;
an aperture in the connecting section, passing into the passageway and at least partially positioned in the first plane; and
drive means operative to both drive the second auger section and rotate the member.

2. The auger assembly of claim 1 wherein the passageway defined by the connecting section has at least a first portion with an internal circular cross-section, wherein the member is mounted in the first portion of the connecting section and wherein the swept area is substantially circular.

3. The auger assembly of claim 2 wherein an annulus is formed between the circular swept area and the internal circular cross-section of the first portion of the connecting section.

4. The auger assembly of claim. 1 wherein the rotation of the member moves particulate material, collected in the channel, along the length of the channel and out the open end at the first end of the member.

5. The auger assembly of claim 1 wherein the intake end of the first auger section comprises a hopper.

6. The auger assembly of claim 1 wherein the connecting section forms a discharge spout for the discharge end of the first auger section.

7. The auger assembly of claim 6 wherein the connecting section is fixedly attached to the discharge end of the first auger section and rotatably connected to the intake end of the second auger section.

8. The auger assembly of claim 1 wherein the drive means comprises a shaft passing through the passageway defined by the connecting section to drive the first auger section and the member is connected to the shaft by a second end.

9. The auger assembly of claim 1 wherein a cover is placed over the aperture and is removable to allow a sample of particulate material to be taken.

10. An auger assembly having a sampling device for collecting a sample of particulate material passing through the auger assembly, the auger assembly comprising:
a first auger section having an intake end and a discharge end, the first auger section operative to move particulate material from the intake end of the first auger section to the discharge end of the first auger section;
a second auger section having an intake end and a discharge end, the second auger section operative to move particulate material from the intake end of the second auger section to the discharge end of the second auger section;
a connecting section defining a passageway and positioned between the discharge end of the first auger section and the intake end of the second auger section, the connecting section operative to direct a flow of particulate material exiting from the discharge end of the first auger section through the passageway to the intake end of the second auger section while the auger assembly is in operation;
an elongate member rotatably mounted in the connecting section and having a channel substantially facing into the flow of particulate material through the passageway while the auger system is in operation, the channel having an open end at a first end of the member, the member rotatably mounted in the connecting section so that rotation of the elongate member causes the member to sweep substantially through a cross-section of the flow of particulate material passing through the passageway while the auger assembly is in operation and collecting a portion of the flow of particulate material in the channel, wherein the rotation of the member forces the particulate material collected in the channel along a length of the channel and out the open end at the first end of the member;
an aperture in the connecting section passing into the passageway and positioned so that at least a portion of the particulate material being forced out the open end of the first end of the member will exit the connecting section through the aperture; and
drive means operative to both drive the second auger section and rotate the member.

11. The auger assembly of claim 10 wherein the passageway defined by the connecting section has at least a first portion with an internal circular cross-section, wherein the member is mounted in the first portion of the connecting section and wherein the swept area is substantially circular.

12. The auger assembly of claim 11 wherein an annulus is formed between the circular swept area and the internal circular cross-section of the first portion of the connecting section.

13. The auger assembly of claim 10 wherein the connecting section forms a discharge spout for the discharge end of the first auger section.

14. The auger assembly of claim 13 wherein the connecting section is fixedly attached to the discharge end of the first auger section and rotatably connected to the intake end of the second auger section.

15. The auger assembly of claim 10 wherein a cover is placed over the aperture and is removable to allow a sample of particulate material to be taken.

16. A method of collecting a sample of particulate material from an auger assembly having a first auger section and a second auger section connected with a connecting section between the discharge end of the first auger section and the intake end of the second auger section, the method comprising:
while the auger assembly is in operation, rotating an elongate member, in the connecting section, in a plane substantially perpendicular to a flow of particulate material passing from the discharge end of the first auger to the intake end of the second auger section;
collecting some of the flow of particulate material in a channel in the elongate member as the flow of particulate material passes the rotating member;
moving the particulate material collected in the channel towards an open end of the member by continuing to rotate the member; and
ejecting a portion of the particulate material from the open end of the channel out of the connecting section.

17. The method of claim 16 wherein the member is rotated by drive means that also drive the first auger section.
